(19) United States
(12) Patent Application Publication
(10) Pub. No.: US 2015/0077899 A1
(43) Pub. Date: Mar. 19, 2015

(54) GRAPHENE-BASED METALLIC POLYMER DOUBLE-LAYER SUPERCAPACITOR

(71) Applicant: Charles Welch, Santa Rosa, CA (US)

(72) Inventor: Charles Welch, Santa Rosa, CA (US)

(21) Appl. No.: 14/489,384

(22) Filed: Sep. 17, 2014

Related U.S. Application Data
(60) Provisional application No. 61/879,052, filed on Sep. 17, 2013.

(51) Int. Cl. H01G 11/52; H01G 11/62; H01G 11/60

(52) U.S. Cl. CPC H01G 11/52; H01G 11/60; H01G 11/62
USPC 361/502

(57) ABSTRACT

A multilayered graphene-based supercapacitor, including a generally planar separator with a plurality of graphene sheets on each side of the separator, wherein each of the graphene sheets on each side of the separator are separated by a layer of electrically conductive metallic adhesive or encapsulant.

### CROSS REFERENCES TO RELATED APPLICATIONS

The present application claims the benefit of U.S. Provisional Patent Application Ser. No. 61/879,052, filed Sep. 17, 2013 (Sep. 17, 2013), incorporated in its entirety by reference herein.

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION BY REFERENCE OF MATERIAL SUBMITTED ON A COMPACT DISC

Not applicable.

### BACKGROUND OF THE INVENTION

1. Field of the Invention

The present invention relates most generally to electrical energy storage devices, and more particularly to a graphene-based metallic polymer double layer supercapacitor, as well as to methods of making the same.

2. Background Discussion

Supercapacitors operate at very high charge and discharge rates over a lifetime of over a million cycles. However, their storage capacity is so significantly lower than that of batteries that their adoption is limited for use in industrial and commercial applications where power density and high life cycles are required. Even so, capacitors have several advantages over batteries. Batteries have a finite shelf life. Accordingly, if a capacitor could be designed with increased energy density without diminishing either power density or cycle life, it would have many advantages over a battery in certain applications. Thus, it would be desirable to develop a high energy density/high power density capacitor with a long cycle life. The present invention provides such a device. Relevant art worth noting in consideration of the invention described herein includes:

U.S. Pat. Appl. Pub. No. 2012/0134072 by Bae et al., discloses electrodes having a multi-layered supercapacitor, including at least two active material layers formed on an electrode current collector or including at least two active material layers formed on an electrode current collector. The electrodes include at least two activated carbon layers and a graphene layer to reduce the internal resistance and stacked in a multi layered structure. The electrodes increase capacitance due to the large specific surface area of the activated carbon and reduce the internal resistance due to the electrical conductivity of the graphene, improving both capacitance and conductivity.

U.S. Pat. Appl. Pub. No. 2013/016811, by Zhou et al, describes a composite supercacitor electrode material of manganese oxide, graphene, and graphite oxide manufactured by milling graphene, ultrasonic dispersing it water; dissolving hypermanganate into the water containing graphene and obtaining the aqueous solution containing permanganate ion and graphene; adding polyethylene glycol into the aqueous solution and stirring and obtaining a mixed solution; stirring the mixed solution until fuchsia completely fades, then filtering, washing and drying precipitate and obtaining the composite electrode material with high specific surface area, high conductivity, and high specific capacity.

Zhu et al, describe a supercapacitor in which they used chemical activation of exfoliated graphite oxide to synthesize a porous carbon with a Brunauer-Emmett-Teller surface area of up to 3100 square meters per gram, a high electrical conductivity, and a low oxygen and hydrogen content. The sp2-bonded carbon has a continuous three-dimensional network of highly curved, atom-thick walls that form primarily 0.6- to 5-nanometer-width pores. Two-electrode supercapacitor cells constructed with the carbon yielded high values of gravimetric capacitance and energy density with organic and ionic liquid electrolytes. [Carbon-Based Supercapacitor Produced by Activation of Graphene, Science, Vol. 332, 24 Jun. 2011, pp. 1537-1541.]

Stoller et al teach a new carbon material called chemically modified graphene (CMG), which are materials made from 1-atom thick sheets of carbon, functionalized as needed. The authoring team demonstrated their performance in an ultracapacitor cell. Specific capacitances of 135 and 99 F/g in aqueous and organic electrolytes, respectively, were measured. [Graphene-Based Ultracapacitors, Nano Letters, Vol. 8, No. 10, 2008, pp. 3498-3502.]

The foregoing patents and scholarly articles reflect the current state of the art of which the present inventor is aware. Reference to, and discussion of, these patents is intended to aid in discharging Applicant's acknowledged duty of candor in disclosing information that may be relevant to the examination of claims to the present invention. However, it is respectfully submitted that none of the above-indicated publications disclose, teach, suggest, show, or otherwise render obvious, either singly or when considered in combination, the invention described and claimed herein.

### BRIEF SUMMARY OF THE INVENTION

The present invention is a high energy density, high power density capacitor with a long cycle life. In a preferred embodiment, it is fabricated in a multilayered configuration with a generally planar separator disposed between a plurality of graphene sheets on each side of the separator. The graphene sheets on each side of the separator are each separated by a layer of electrically conductive metallic adhesive or encapsulant.

### BRIEF DESCRIPTION OF SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a highly schematic exploded side view in elevation of a first preferred embodiment of the graphene-based metallic polymer dual layered supercapacitor of the present invention;

FIG. 1A is an upper perspective view of the first preferred embodiment;

FIG. 1B is an upper perspective view showing the first preferred embodiment encapsulated in a thermally resistant wrapper or seal so as to prevent electrolyte from leaking from the separator/electrolyte layer of the assembly;

FIG. 1C is a partial cross sectional view thereof showing the wrapper removed at an end; and

FIG. 2 is a highly schematic side view in elevation showing a second preferred embodiment of the inventive supercapacitor.

### DETAILED DESCRIPTION OF THE INVENTION

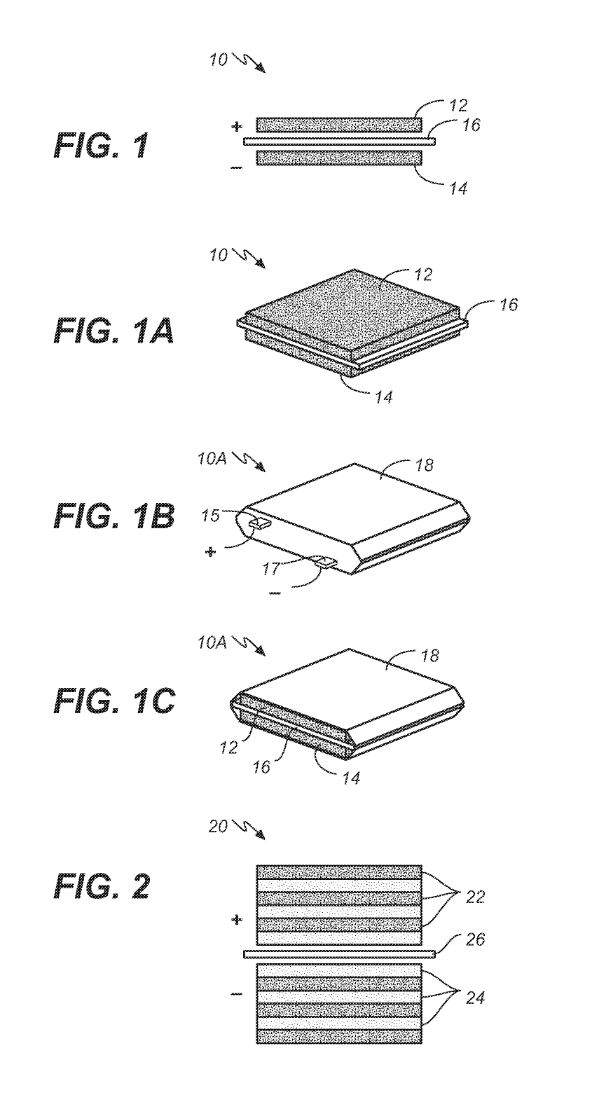

Referring to FIGS. 1 through 2, wherein like reference numerals refer to like components in the various views, there is illustrated therein a new and improved graphene-based metallic polymer dual layered supercapacitor.

Referring first specifically to FIGS. 1 through 1C, in a first preferred embodiment, there is provided a graphene-based supercapacitor comprising a first graphene metallic layer (or plate) 12, a second graphene metallic layer (or plate) 14, and an electrolyte/separator 16 disposed between the first and second graphene metallic layer comprising an electrolyte with a separator.

The graphene metallic material in the graphene metallic layers is fabricated from exfoliated graphene dispersed in a conductive adhesive or encapsulant. An exemplary such encapsulant or adhesive may be, by way of example, silver epoxy, such as Henkel Loctite 3888 conductive adhesive silver, or Resin Technology 402 electrically conductive epoxy adhesive silver, Resinlab SEC 1233 electrically conductive epoxy adhesive silver, or MG Chemical's 8331 silver conductive epoxy.

Once mixed with the graphene, the conductive silver epoxy exhibits an extremely high conductivity. The concentration of graphene in the silver epoxy can be tailored to achieve a desired conductivity. In the preferred embodiment, the resistance of the silver epoxy is approximately 0.017 Ohms per cm.

The fabrication process begins with a sheet of exfoliated graphene. Once the sheet is obtained, graphene is scraped off and measured in a predetermined amount. An appropriate volume silver conductive epoxy is mixed with the graphene until a homogeneous graphene silver epoxy is achieved. Once a consistent graphene silver composition is achieved, it is coated on a flexible planar substrate to set and cure. Once cured, it is arranged in a plate configuration with an identical graphene silver plate having an electrolyte and separator disposed between the two graphene silver epoxy plates.

The separator 16 is preferably a single layer of micro-porous polypropylene plastic soaked in an organic electrolyte. The preferred electrolyte is tetraethylammonium tetrafluoroborate dissolved in aqueous acetonitrile.

Once configured as described, the capacitor is sealed around the edges of the plates and separator with a thermally resistant tape 18 or a polymer seal to prevent the electrolyte from leaking Positive and negative leads 15, 17, respectively, extend from a side of the sealed package. To obviate the need for such a seal, a solid-state double layer capacitor can be produced by mixing the electrolyte in a polyvinyl acetate (PVA) polymer mixture and applied as a layer between the first and second graphene silver layers and arranged into a double layer capacitor.

From the foregoing it will be appreciated that the inventive supercapacitor uses a conductive metallic medium to facilitate a higher concentration and energy density on the capacitor conductors due to a variable amount of conductive graphene in the conductive medium. It will be further appreciated that the concentration and energy density can be very finely tailored by using any of a number suitably conductive media in which to mix the graphene.

Referring now to FIG. 2, in a second preferred embodiment 20 there is provided a variable multilayer graphene metallic based supercapacitor. This embodiment includes a plurality of graphene sheets 22 on each side of the separator 26, each of the graphene layers separated by a layer of electrically conductive metallic adhesive or encapsulant 24. This two-sided multilayered sandwich facilitates greatly increased energy storage and electron mobility.

In a first preferred method of manufacture, the multilayered capacitor is fabricated by first arranging graphene sheets and coating them with conductive silver epoxy. Once the entire graphene sheet is coated with a conductive silver epoxy, a layer of aqueous graphite oxide is coated on top of the conductive silver epoxy. After the aqueous graphite oxide has set into a solid it can be oxidized into graphene. After that an architecture or arrangement of a graphene sheet, conductive silver, graphene sheet, conductive silver, etc., can be achieved, with the number of layers selected according to the desired energy density, power density, and cycle life. While FIG. 2 shows only three layers of graphene and encapsulant, it may include layers numbering in the hundreds on each side of the separator. And while this might seem to suggest the production of a bulky device, due to the extremely small size of graphene and thinness of graphene sheets, even using hundreds of layers would still enable effective miniaturization while also providing an energy dense capacitor.

After each side of the multilayered configuration is completed, the capacitor can be assembled similarly to the first preferred embodiment, wherein an electrolyte and separator is disposed between the multilayered sides.

Once arranged, the layers of graphene can be wired together using a copper tape, or the electricity can flow between the layers through the silver medium. This allows for multiple layers of energy storage and for the transfer of electricity through the conductive silver.

Tests have shown silver epoxy to be particularly well suited for use as an adhesive/encapsulant. Even so, the conductive medium between the graphene sheets can be varied using a number of different materials (e.g., copper, silicon, etc.).

A capacitor configured according to either of the above-described preferred embodiments resolves the problem of rapid discharges characteristic of currently known graphene-based supercapacitors. The layers of conductive silver disposed between the graphene provide small amounts of resistance to contain charge within the respective graphene layers. Additionally, the inventive configuration helps to transmit the charge when accessed. This makes the present invention an extremely diverse and efficient new style of capacitor capable of a wide range of applications.

In still another embodiment, rather than soaking the microporous separator sheet in an organic electrolyte, such as the tetraethylammonium tetrafluoroborate dissolved in aqueous acetonitrile, as described above, an ionic liquid bath may instead be employed. Testing has shown 1-ethyl-3-methylimadozium tetrafluoroborate to be another suitable separator substance. Using this ionic liquid, the inventive capacitor can hold even more charge than those using an electrolytic solution.

The use of an ionic liquid separator calls for another approach to manufacturing the inventive supercapacitor. In this approach the product assembly is completed in an inert gas environment. If assembly is conducted by hand, it may be done in an inert gas-filled glove box environment. This is to prevent the ionic liquid from being exposed to air, because it will rapidly reacts with oxygen and lose its electrical properties.

Making Lower Resistivity Graphene: A multi-layered high charge density supercapacitor must have the optimal material properties of graphene. Experiments show that a CO₂ laser cutter can be used to reduce graphite oxide to graphene and thus to produce the lowest resistance material possible, especially with respect to low sheet resistance and a very low resistivity. This comprises a significant improvement over the DVD writer method of producing graphene developed by Richard Kaner and a team of researchers at UCLA, and it produces a very low resistance graphene which exhibits better characteristics compared to the graphene produced using DVD writer laser.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve, most notably, alternative materials for the graphene/conductive metallic composition, though the use of graphene in conductors configured in other than a parallel plate configuration is also contemplated herein.

Therefore, the above description and illustrations should not be construed as limiting the scope of the invention, which is defined by the appended claims.

What is claimed as invention is:

1. A graphene-based supercapacitor, comprising:
a first graphene metallic layer;
a second graphene metallic layer; and
a separator disposed between said first and second graphene metallic layer, said separator including an electrically conducting fluid.

2. The graphene-based supercapacitor of claim 1, wherein said separator includes a membrane substrate soaked with said electrically conducting fluid and said electrically conducting fluid is an electrolyte dissolved in an ionizing solvent, and further wherein the combined membrane substrate and electrically conducting fluid are cured.

3. The graphene-based supercapacitor of claim 2, wherein said electrolyte is an organic electrolyte dissolved in an ionizing solvent.

4. The graphene-based supercapacitor of claim 3, wherein said electrolyte is tetraethylammonium tetrafluoroborate.

5. The graphene-based supercapacitor of claim 4, wherein and said ionizing solvent is aqueous acetonitrile.

6. The graphene-based supercapacitor of claim 1, wherein each of said first and second graphene metallic layers are fabricated from exfoliated graphene dispersed in a conductive encapsulant.

7. The graphene-based supercapacitor of claim 6, wherein said conductive encapsulant is a conductive adhesive.

8. The graphene-based supercapacitor of claim 6, wherein said conductive adhesive is silver epoxy.

9. The graphene-based supercapacitor of claim 6, wherein said conductive adhesive is conductive adhesive silver.

10. The graphene-based supercapacitor of claim 1, wherein said separator is made by soaking a membrane substrate in an electrically conducting fluid and then curing the combination.

11. The graphene-based supercapacitor of claim 10, wherein said membrane substrate is micro-porous polypropylene plastic.

12. The graphene-based supercapacitor of claim 1, wherein said separator comprises an electrolyte mixed in a polyvinyl acetate mixture.

13. A multilayered graphene-based supercapacitor, comprising:
a generally planar separator;
a stacked configuration of a plurality of alternating layers of graphene sheets and electrically conductive metallic adhesive or encapsulant disposed on each side of said separator, each of said graphene sheets on each side of said separator separated by a layer of electrically conductive metallic adhesive or encapsulant.

14. The graphene-based supercapacitor of claim 13, wherein said electrically conductive metallic adhesive or encapsulant is conductive silver epoxy.

15. The graphene-based supercapacitor of claim 13, wherein said plurality of graphene sheets on each side of said separator are each wired together to the other graphene sheets on the same side of said separator such that ions can flow between the graphene sheet layers through said electrically conductive metallic adhesive or encapsulant.

16. The graphene-based supercapacitor of claim 13, wherein said separator includes a membrane substrate soaked in an electrically conducting fluid.

17. The graphene-based supercapacitor of claim 16, wherein said electrically conducting fluid is an electrolyte dissolved in an ionizing solvent, and wherein said electrically conducting fluid and said membrane substrate are combined and cured.

18. The graphene-based supercapacitor of claim 17, wherein said electrolyte is tetraethylammonium tetrafluoroborate.

19. The graphene-based supercapacitor of claim 17, wherein said ionizing solvent is aqueous acetonitrile.

20. The graphene-based supercapacitor of claim 17, wherein each of said first and second graphene metallic layers are fabricated from exfoliated graphene dispersed in a conductive encapsulant.

21. The graphene-based supercapacitor of claim 16, wherein said membrane substrate is micro-porous polypropylene plastic.

22. The graphene-based supercapacitor of claim 13, wherein said separator comprises an electrolyte and polyvinyl acetate mixture.
